(19) United States
(12) Patent Application Publication
(10) Pub. No.: US 2026/0197237 A1
(43) Pub. Date: Jul. 9, 2026

(54) Power Usage at Telco Edge Clusters

(71) Applicant: Dell Products L.P., Round Rock, TX (US)

(72) Inventors: Ramesh Ganapathi, Chennai (IN); Sanjeev Sharma, Bengaluru (IN); Mihai Lazar, Nepean (CA); Vinay Sawal, Fremont, CA (US)

(21) Appl. No.: 19/015,572

(22) Filed: Jan. 9, 2025

(51) Int. Cl. H04L 41/0833; G06N 3/096; H04L 41/00

(52) U.S. Cl. CPC H04L 41/0833; G06N 3/096; H04L 41/32

(57) ABSTRACT

A system can identify data regarding facilitation of broadband cellular communications at edge network equipment. The system can process the data using a first local artificial intelligence model to produce anonymized embeddings that correspond to the data and that differ from artificial intelligence model gradients. A central scaling platform aggregates the anonymized embeddings, received from respective edge network equipment, into a group of anonymized embeddings, and trains a global artificial intelligence model based on the group of anonymized embeddings. The system can receive, from the central scaling platform, an update to a second local artificial intelligence model based on the trained global artificial intelligence model. The system can implement a scale up operation or a scale down operation of the edge network equipment based on an output of the second local artificial intelligence model.

### BACKGROUND

A broadband cellular network can facilitate communications by user equipment (UE).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can identify data regarding facilitation of broadband cellular communications at the edge network equipment, wherein the edge network equipment is part of a broadband cellular network. The system can process the data using a first local artificial intelligence model to produce anonymized embeddings that correspond to the data, wherein the anonymized embeddings differ from artificial intelligence model gradients. The system can send the anonymized embeddings to a central scaling platform that aggregates the anonymized embeddings into a group of anonymized embeddings, and that trains a global artificial intelligence model based on the group of anonymized embeddings, to produce trained global artificial intelligence model, wherein respective anonymized embeddings of the group of anonymized embeddings are received from respective edge network equipment of a group of edge network equipment that comprise the edge network equipment. The system can receive, from the central scaling platform, an update to a second local artificial intelligence model based on the trained global artificial intelligence model. The system can implement a scale up operation or a scale down operation of the edge network equipment based on an output of the second local artificial intelligence model.

An example method can comprise processing, by an edge site comprising at least one processor and that is part of a broadband cellular network, telemetry data generated at the edge site a first local artificial intelligence model to produce anonymized embeddings that correspond to the telemetry data, wherein the anonymized embeddings differ from artificial intelligence model gradients. The method can further comprise sending, by the edge site, the anonymized embeddings to a central scaling platform that aggregates the anonymized embeddings into a group of anonymized embeddings, and that trains a global artificial intelligence model based on the group of anonymized embeddings, to produce trained global artificial intelligence model. The method can further comprise receiving, by the edge site and from the central scaling platform, an update to a second local artificial intelligence model based on the trained global artificial intelligence model. The method can further comprise, based on an output of the second local artificial intelligence model, implementing, by the edge site, a first operation that modifies at least one parameter applicable to the edge site to increase at least one performance of the edge site or a second operation that modifies the at least one parameter applicable to the edge site to decrease the at least one performance of the edge site.

An example non-transitory computer-readable medium can comprise instructions that, in response to execution, cause a system comprising a processor to perform operations. These operations can comprise locally processing data that is generated locally with a first local model to produce anonymized embeddings that correspond to the data, wherein the anonymized embeddings independent of gradients of an artificial intelligence model. These operations can further comprise sending the anonymized embeddings to a remote computing system that aggregates the anonymized embeddings into a group of anonymized embeddings, and that trains a global model based on the group of anonymized embeddings, to produce trained global model. These operations can further comprise receiving, from the remote computing system, an update to a second local model based on the trained global model. These operations can further comprise implementing a local scale up operation or a local scale down operation based on an output of the second local model.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate improved power usage at telco edge clusters, in accordance with an embodiment of this disclosure;

FIG. 2 illustrates another example system architecture that can facilitate improved power usage at telco edge clusters, in accordance with an embodiment of this disclosure;

FIG. 3 illustrates another example system architecture of global model training, and that can facilitate improved power usage at telco edge clusters, in accordance with an embodiment of this disclosure;

FIG. 4 illustrates an example table of embeddings, and that can facilitate improved power usage at telco edge clusters, in accordance with an embodiment of this disclosure;

FIG. 5 illustrates an example system architecture for aggregating embeddings for a global model, and that can facilitate improved power usage at telco edge clusters, in accordance with an embodiment of this disclosure;

FIG. 6 illustrates an example table of attributes, and that can facilitate improved power usage at telco edge clusters, in accordance with an embodiment of this disclosure;

FIG. 7 illustrates another example table of attributes, and that can facilitate improved power usage at telco edge clusters, in accordance with an embodiment of this disclosure;

FIG. 8 illustrates an example of scaling up, and that can facilitate improved power usage at telco edge clusters, in accordance with an embodiment of this disclosure;

FIG. 9 illustrates an example of scaling down, and that can facilitate improved power usage at telco edge clusters, in accordance with an embodiment of this disclosure;

FIG. 10 illustrates another example of scaling down, and that can facilitate improved power usage at telco edge clusters, in accordance with an embodiment of this disclosure;

FIG. 11 illustrates an example process flow that can facilitate improved power usage at telco edge clusters, in accordance with an embodiment of this disclosure;

FIG. 12 illustrates another example process flow that can facilitate improved power usage at telco edge clusters, in accordance with an embodiment of this disclosure;

FIG. 13 illustrates another example process flow that can facilitate improved power usage at telco edge clusters, in accordance with an embodiment of this disclosure;

FIG. 14 illustrates an example block diagram of a computer operable to execute an embodiment of this disclosure.

### DETAILED DESCRIPTION

### Overview

The examples herein generally relate to fifth generation (5G) broadband cellular networks. It can be appreciated that the present techniques can be applied to other types of broadband cellular networks, such as fourth generation (4G) networks, Long Term Evolution (LTE) networks, and sixth generation (6G) networks.

As communications service providers (CSPs) transition from traditional telecom solutions to modern cloud-native, open, disaggregated solution architectures, they can look for options that preserve choice, yet offer a reliable, total cost of ownership (TCO) efficient foundation to build upon. While 5G broadband cellular technologies can offer an opportunity for CSPs to provide new services and applications, they can introduce changes and new challenges due to a large scale of 5G deployments.

Some problems can relate to:
network densification and complexity;
automation and manageability;
time to market; and
total cost of ownership.

In addition, a factor that can contribute to these problems can be a lack of experience/skills in the management of a distributed network edge.

Without proper processes and capabilities in place, prior approaches of slow, labor-intensive operations in this environment undermine the cost, agility, and scalability benefits of new telecommunications (telco) technologies like Open Radio Access Network (RAN) architectures.

Edge telco deployments can use micro-datacenters implemented with ruggedized equipment racks placed in a physical container. These micro-datacenters can have unique challenges with respect to electrical power consumption and climate control (e.g., cooling). They can be located in remote locations, with harsh climate conditions and in some cases with unreliable electricity sources. Thus, these systems can have special cooling requirements and can be fitted with backup batteries.

The total workload (compute power) requirements for server clusters at a specific edge micro-datacenter can vary over time. In some situations, the servers are mainly idle (e.g., very few connected users), while in some other cases, the workload increases significantly (e.g., “busy times,” social events occurring in their area of coverage, etc.).

The power consumption of an idle or lightly loaded server can be relatively significant and can add to cooling needs and overall electricity costs. Therefore, it can be advantageous to migrate their (light) workloads somewhere else (“scale-down and migrate”) and entirely shut down such servers. However, in the case where the workload placed on the local cluster increases, it can be that the previously powered-off servers must be powered up again and added to the cluster. Since bringing up and adding a server to a cluster can take a relatively long amount of time, it can be that the latter action must be performed in advance to accommodate the workload increase.

In some cases, telcos pre-position (“rack and stack”) servers at edge micro-datacenters to deal with future workload increases (these servers can be referred to as “server inventory”). They can either power them on, which can unnecessarily increase power utilization, or keep them powered off and manually turn them on when the workload increases, which can be an operational challenge.

There can be problems that relate to scaling down. To save power, the existing underutilized workload cluster size can be reduced by powering down node(s) that are lightly or not lightly utilized. In some examples, nodes that are idle or underutilized can be considered for powering down where it is feasible to consolidate running workloads on other node(s).

Prior approaches to monitor the underutilized cluster and its non-utilized nodes, and to determine the feasibility to consolidate workloads on other nodes from underutilized nodes can be a manual process, which is effort-intensive, error prone and time-consuming. The time and effort to scale down the cluster can vary depending on the cluster size and setup complexities.

Consider an example cluster comprising three servers with 32 central processing unit (CPU) cores each. The running average cluster's CPU utilization over the period of time is 50%.

In this example, the compute capacity utilization corresponds to only 1.5 servers (out of 3)—50% of the total cluster capacity. However, all three nodes of the cluster are drawing power and contributing to the cooling requirements.

There can be problems that relate to scaling up. When existing edge cluster compute capacity is insufficient to meet workload deployment requirements, it can be that new servers/node(s) are powered up and added to the cluster to increase its capacity (“scale up”). This can refer to powered off pre-installed servers, and not installation of new servers.

Workload deployment requirements can depend on factors such as compute, memory, storage, acceleration, and scheduling constraints. Prior approaches of analyzing workload requirements and the available cluster resources, as well as adding the new nodes to the cluster, can be a manual process.

This can make it effort-intensive and time-consuming, and can lead to delays in onboarding and operationalizing workloads. This time and effort can vary depending on the cluster scale and setup complexities. This can pose a challenge to a CSP's service level agreements (SLAs), such as in terms of how fast the service becomes available while keeping the cluster efficient.

Consider an example cluster with three servers with 32 CPU cores each. In this example, one of the server is powered off, and two servers are powered on.

The running average cluster's CPU utilization over the period of time is 90%. In a given scenario, if the workload requirement increases, it can be that all three nodes of the cluster are needed to operate to meet the SLA requirement of the cluster.

The present techniques can be implemented for extracting site-specific features using “feature vectors.” The feature vectors can provide an anonymized and abstracted representation of telco edge site attributes. This approach can provide a way to obtain larger AI training datasets and aggregate data from multiple telcos and edge sites, and can allow training to be done with both common (to all sites, or a subset of sites) and site-specific features.

In contrast to federated learning, where each local model processes local data and generates gradients that are sent to the global model, according to the present techniques, local ML models can extract feature vectors from telco edge sites and deployments. Anonymization and data abstraction can be obtained by using feature vectors rather than model gradients.

The present techniques can be implemented to facilitate an optimized (or a sufficiently satisfactory), platform independent, and resource agnostic AI prediction model.

Using feature vectors from multiple telcos and edge sites for the training of a global AI model can increase accuracy and improves the performance of the model's prediction capabilities.

Feature vectors can abstract and anonymize local site data, thus such an AI model can be platform independent and resource agnostic.

Once the global model is trained, it can be available for inferencing to all local sites.

Implementing the present techniques can offer the following benefits. They can enable telcos to predict increased workloads and resource utilization. They can enable automatic activation of previously power-down servers well ahead in advance of actual upsurges, thus allowing for enough time for server and cluster bring-up and workload migration. Conversely, being able to reliably predict decreased resource utilization can allow telcos to automatically power down unused servers, while knowing that it is possible to do so without jeopardizing service level agreements.

They can ensure service level agreements (SLAs) are respected, such as by automatically increasing compute power, by powering on deactivated servers at 5G edge micro-datacenters, ahead of the time when workloads are predicted to increase.

They can save electrical power by automatically shutting down unused or underutilized servers.

### Example Architectures, Etc

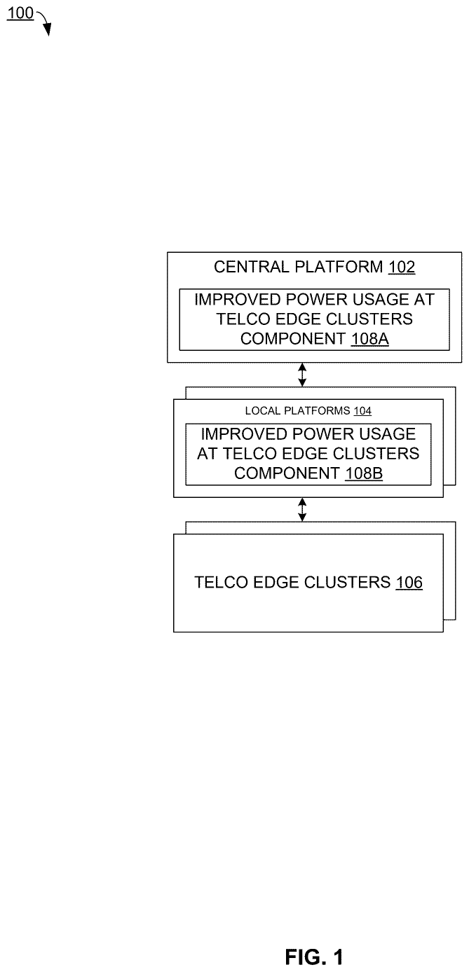

FIG. 1 illustrates an example system architecture 100 that can facilitate improved power usage at telco edge clusters, in accordance with an embodiment of this disclosure.

System architecture 100 comprises central platform 102 (which comprises improved power usage at telco edge clusters component 108A), local platforms 104 (where each local platform can comprise an instance of improved power usage at telco edge clusters component 108B), and telco edge clusters 106.

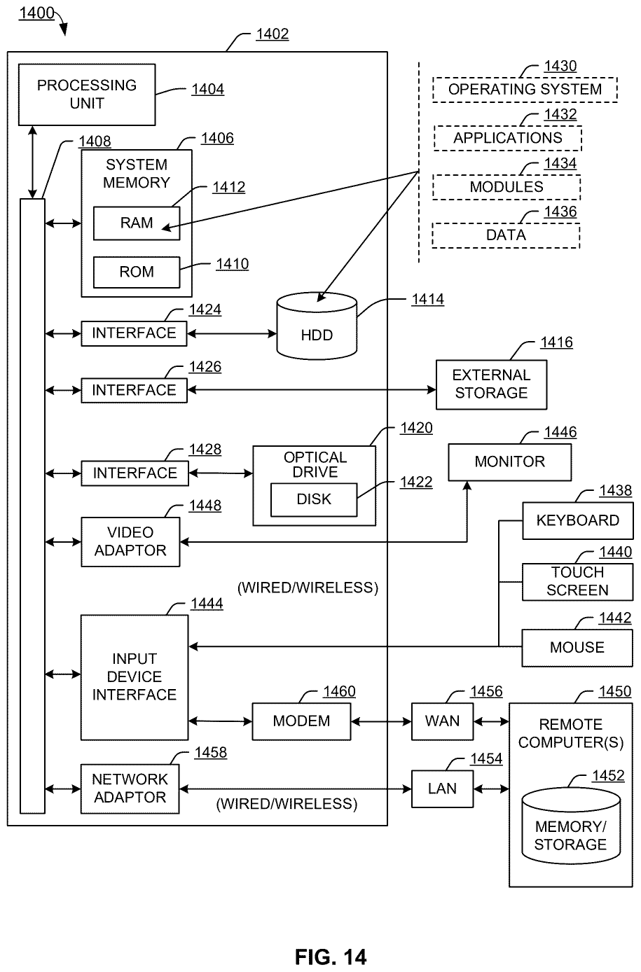

Each of central platform 102, local platforms 104, and/or telco edge clusters 106 can be implemented with part(s) of computing environment 1400 of FIG. 14.

In some examples, instances of improved power usage at telco edge clusters component 108B can create anonymized local embeddings from telemetry data received from respective telco edge clusters of telco edge clusters 106. They can send these embeddings to central platform 102, where improved power usage at telco edge clusters component 108B can train a global model for scaling decisions. Improved power usage at telco edge clusters component 108A can send that model to the instances of improved power usage at telco edge clusters component 108B, which can use it to make local scaling decisions for a corresponding telco edge cluster of telco edge clusters 106.

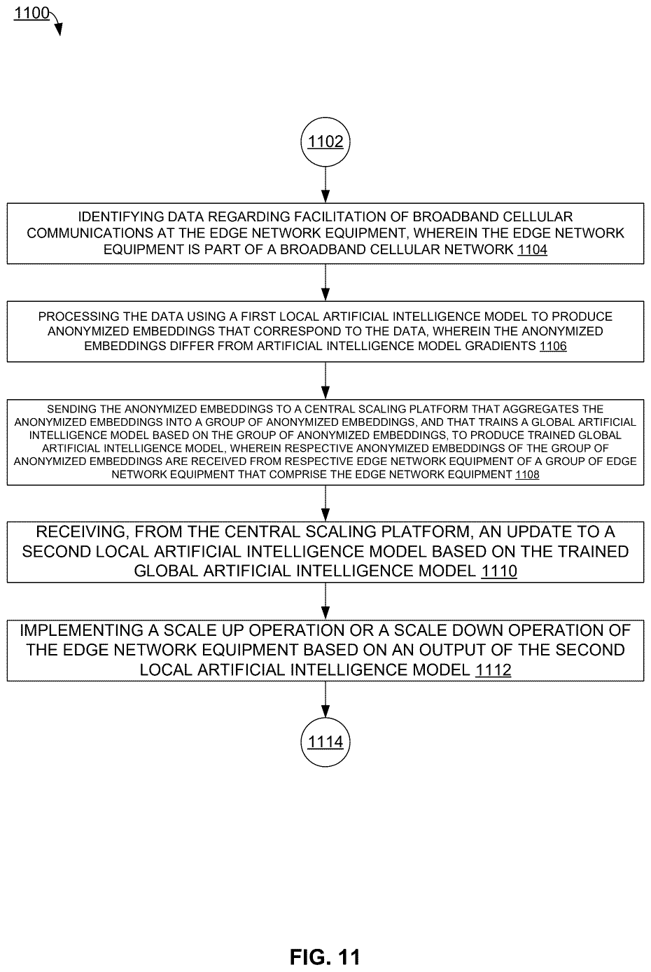

In some examples, improved power usage at telco edge clusters component 108A and/or improved power usage at telco edge clusters component 108B can implement part(s) of the process flows of FIGS. 11-13 to implement improved power usage at telco edge clusters.

It can be appreciated that system architecture 100 is one example system architecture for improved power usage at telco edge clusters, and that there can be other system architectures that facilitate improved power usage at telco edge clusters.

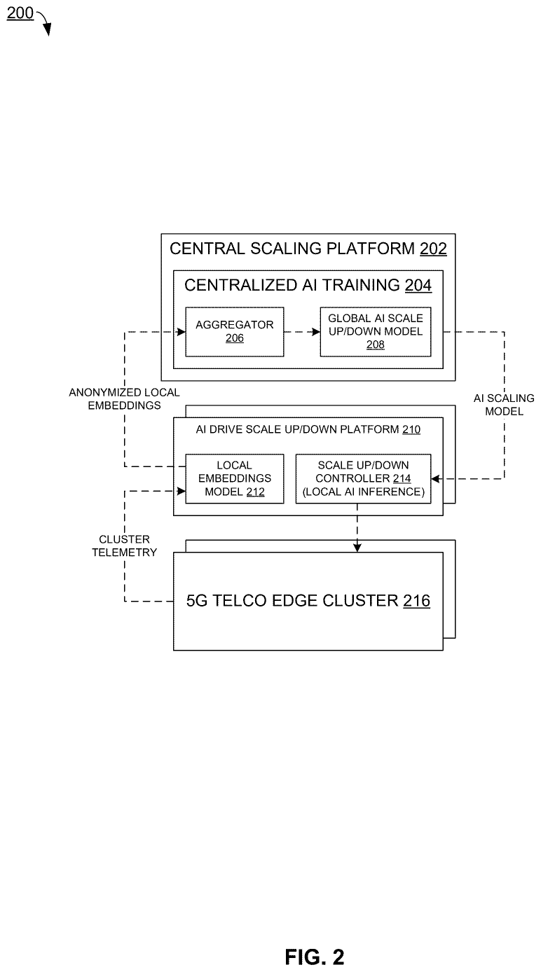

FIG. 2 illustrates another example system architecture 200 that can facilitate improved power usage at telco edge clusters, in accordance with an embodiment of this disclosure. In some examples, part(s) of system architecture 200 can be implemented by part(s) of system architecture 100 of FIG. 1 to facilitate improved power usage at telco edge clusters.

System architecture 200 comprises central scaling platform 202, centralized AI training 204, aggregator 206, global AI scale up/down model 208, AI drive scale up/down platform 210, local embeddings model 212, scale up/down controller 214 (local AI inference), and 5G telco edge cluster 216.

The present techniques can be implemented to facilitate an artificial intelligence (AI)-driven scaling controller to schedule and execute scale up/down operations for telco edge server clusters. A global AI scaling model can be trained using anonymized data from local AI scale up/down models of participating telcos.

Components of an example implantation of the present techniques can comprise:
Central scaling platform;
   Global AI model trained using anonymized data (“embeddings”) from participating telcos.
   Secure per tenant scale up/down results database;
AI driven scaling platform (per telco deployment);
   Scale up/down controller: Automatically powers up and down local servers and aggregates workloads, based on input from the global AI scaling model (e.g., select when to scale down, based on least expected connected users).
      Uses an AI model to infer optimal times to scale up or down the local cluster and predict cluster utilization values.
      The centralized AI model can periodically provide updates to the local controller to avoid AI model drift.
   Local embeddings model: produces per deployment embeddings using local cluster data and participates in global AI training by sending its parameters to the central aggregator.

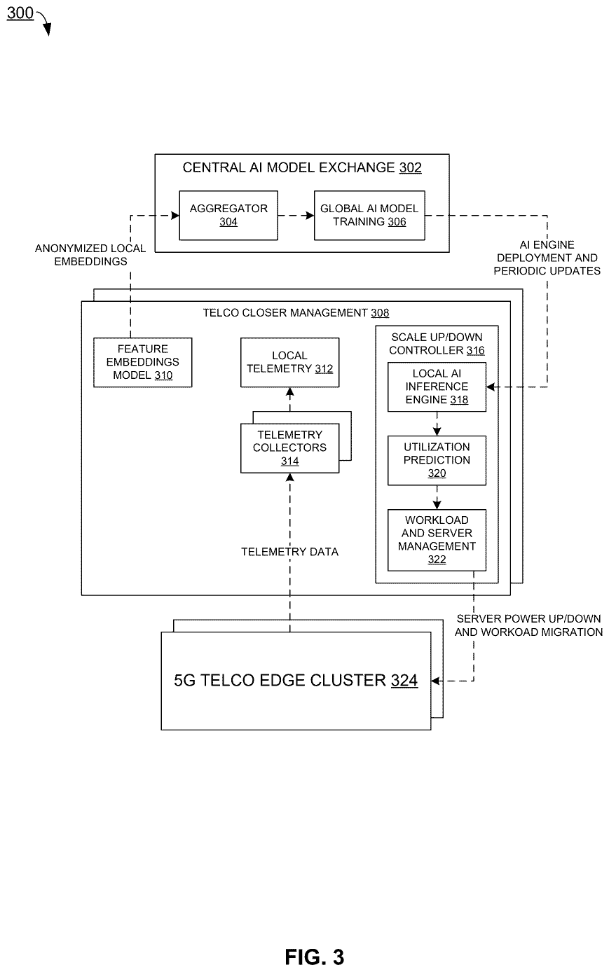

FIG. 3 illustrates another example system architecture 300 of global model training, and that can facilitate improved power usage at telco edge clusters, in accordance with an embodiment of this disclosure. In some examples, part(s) of system architecture 300 can be implemented by part(s) of system architecture 100 of FIG. 1 to facilitate improved power usage at telco edge clusters.

System architecture 300 comprises central AI model exchange 302, aggregator 304, global AI model training 306, telco closer management 308, feature embeddings model 310, local telemetry 312, telemetry collectors 314, scale up/down controller 316, local AI inference engine 318, utilization prediction 320, workload and server management 322, and 5G telco edge cluster 324.

Global model training can be implemented as follows.

Centralized Model Training in Telco deployments can involve:
Initialize global model: Create a central model with random parameters.
Select deployment: Choose participating devices based on factors like availability, data quality, and computational power.
Train models locally for features embeddings (as needed): Each selected edge server can generate embeddings using its own data, keeping sensitive information on-device.
Send parameter updates: It can be that only model embeddings are transmitted to the central aggregator, preserving data privacy.
Aggregation: The central system can combine updates from all participating devices, using techniques like averaging.
Iterate process: Repeat the above training, sending parameters, and aggregating for a set number of rounds or until meeting convergence criteria, continuously improving the global model.

This approach can facilitate collaborative learning while preserving data privacy and accommodating distributed computing resources. In some examples, the following can be implemented:
Local embeddings are used, per deployment and telco;
Model drift can be avoided by periodic updates of the local AI inference engine with the most recent state of the global AI model ;
Telcos can benefit from a large data set collected from:
   Multiple edge clusters;
   Multiple participating telcos (their data can be anonymized);
Run-time considerations:
   Embeddings can be generated in data centers with enough resources;
   Embeddings can require relatively limited resources and have no hard-real time constraints.

The following are example AI model labels and features.

Model features—inputs to an AI model according to the present techniques—can include:
Characteristics of servers to scale down (CPU, memory usage, storage space, etc.);
Characteristics of target servers (used to aggregate workloads);
Server telemetry (CPU, memory, disk space, etc.) over time;
Network latency, reliability and bandwidth;
Number of mobile users connected to a radio unit (RU)/distributed unit (DU);
Signal strength of base station (RU);
Number and locations of failures in the systems;
Internal cluster status;
Workload application types;
Results of previous scale up/down operations:
   Failed or succeeded;
   Estimated duration of operation vs. actual duration;
   Logs and events which occurred during the operation;
   Snapshot of system state before and after the scale up/down operation (server: CPU, memory . . . );
Scale Up Constraints:
   Total maximum duration of a scale up operation per server and cluster;
   Time window for scale up: maximum duration, time of day (range);
   Physical deployment setup;
      Available servers and cluster;
      Physical network topology.

Model labels—outputs from an AI model according to the present techniques—can include:
When it is possible to scale down;
When it is required (or indicated) to scale up;
Which cluster(s) to scale up or down;
Which servers to power on or off, when, and in what order;
Which server to use to aggregate workloads in the case of a scale down operations;
Estimate of the total duration of an operation (scale up/down).

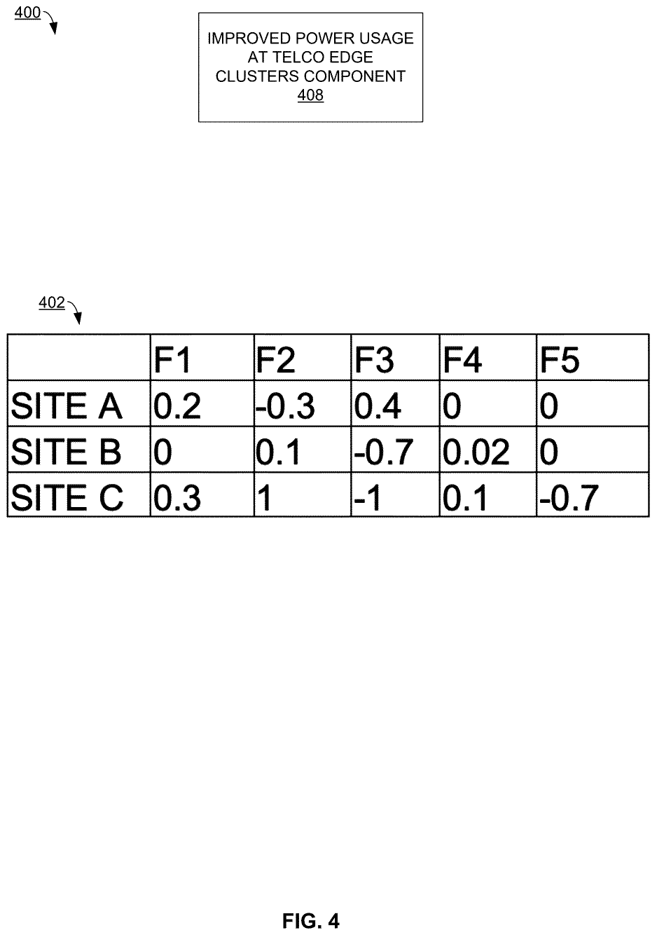

FIG. 4 illustrates an example table 400 of embeddings, and that can facilitate improved power usage at telco edge clusters, in accordance with an embodiment of this disclosure. In some examples, part(s) of table 400 can be implemented by part(s) of system architecture 100 of FIG. 1 to facilitate improved power usage at telco edge clusters.

Table 400 comprises table 402 and improved power usage at telco edge clusters component 408 (which can be similar to improved power usage at telco edge clusters component 108A of FIG. 1).

Training an AI model according to the present techniques can be implemented as follows.

Features of the AI Models can be represented using “embeddings,” which can comprise representations of the telemetry data in a vector space.

The model can define a comprehensive set of features, which can be used at sites. In some examples, only a subset of the overall feature set is in use at a given edge site, while in other examples, all features apply.

For each feature, the model can define a known “value range” and “normalization range.” Using a CPU utilization metric, the value range can vary between 0 and 100%, and the normalization range can vary between −1 and 1. These ranges can apply to all sites.

Each site can use a an AI model (e.g., a recurrent neural network (RNN) or a convolutional neural network (CNN)) to normalize feature values and create embeddings vectors. In some examples, different types/implementations of models can be used at different sites.

With respect to using different models at different sites, consider an example where comprehensive set of features is F1, F2, F3, F4, F5.
Site A only uses features F1, F2, F3
Site B only uses features F2, F3, F4
Site C uses all features F1, F2, F3, F4, F5

Where there is a normalized range of −1 to 1, a set of embeddings for the three sites (representing their states at a given time) could be as depicted. In this case, the value “0” can be used to represent a value for a feature which is not present.

It can be appreciated that there can be examples where at least some features are non-numerical (e.g., the features comprise strings of alphabetical characters).

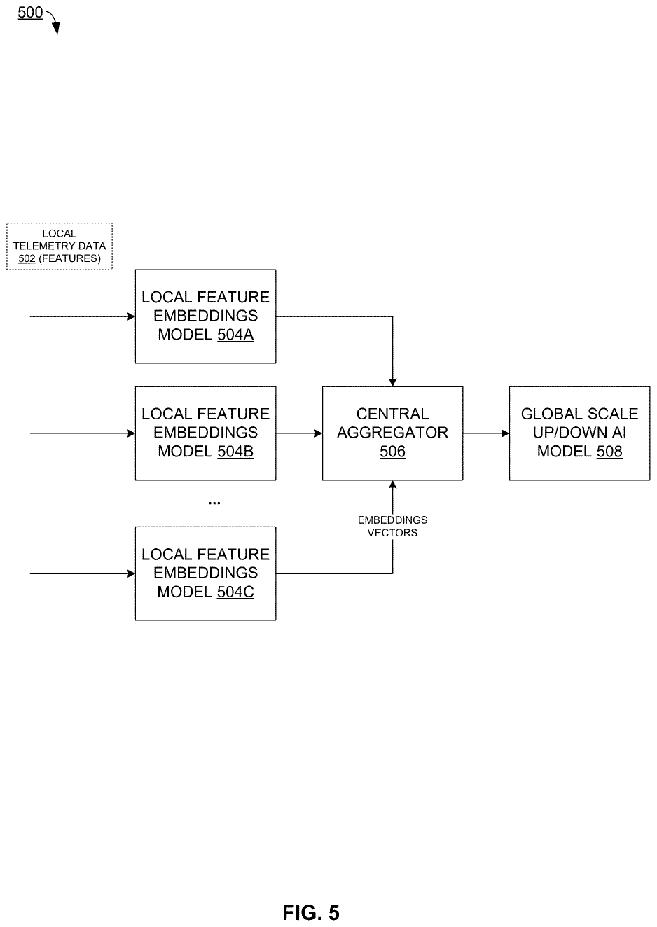

FIG. 5 illustrates an example system architecture 500 for aggregating embeddings for a global model, and that can facilitate improved power usage at telco edge clusters, in accordance with an embodiment of this disclosure. In some examples, part(s) of system architecture 500 can be implemented by part(s) of system architecture 100 of FIG. 1 to facilitate improved power usage at telco edge clusters.

System architecture 500 comprises local telemetry data 502 (features), local feature embeddings model 504A, local feature embeddings model 504B, local feature embeddings model 504C, central aggregator 506, and global scale up/down AI model 508.

Embeddings can be transmitted to a central aggregator, which can aggregate data provided for training the central scale up/down model.

The following are a sample of example metric and trigger features at cluster nodes. Metric features can include AggregationMetrics, CUPS, GPUMetrics, NICStatistics, PSUMetrics, ThermalMetrics, CPUMemMetrics, FanSensor, GPUStatistics, NVMeSMARTData, Sensor, ThermalSensor, CPURegisters, FCSensor, MemorySensor, PowerMetrics, StorageDiskSMARTData, CPUSensor, FPGASensor, NICSensor, PowerStatistics, and StorageSensor.

Trigger features can include CPUCriticalTrigger, MEMWarnTrigger, TMPCpuWarnTrigger, CPUWarnTrigger, NVMeCriticalTrigger, TMPCriticalTrigger, FANCriticalTrigger, NVMeWarnTrigger, TMPDiskCriticalTrigger, FANWarnTrigger, PDRCriticalTrigger, MPDiskWarnTrigger, IERRCriticalTrigger, PDRWarnTrigger, TMPWarnTrigger, MEMCriticalTrigger, TMPCpuCriticalTrigger, and VLTCriticalTrigger.

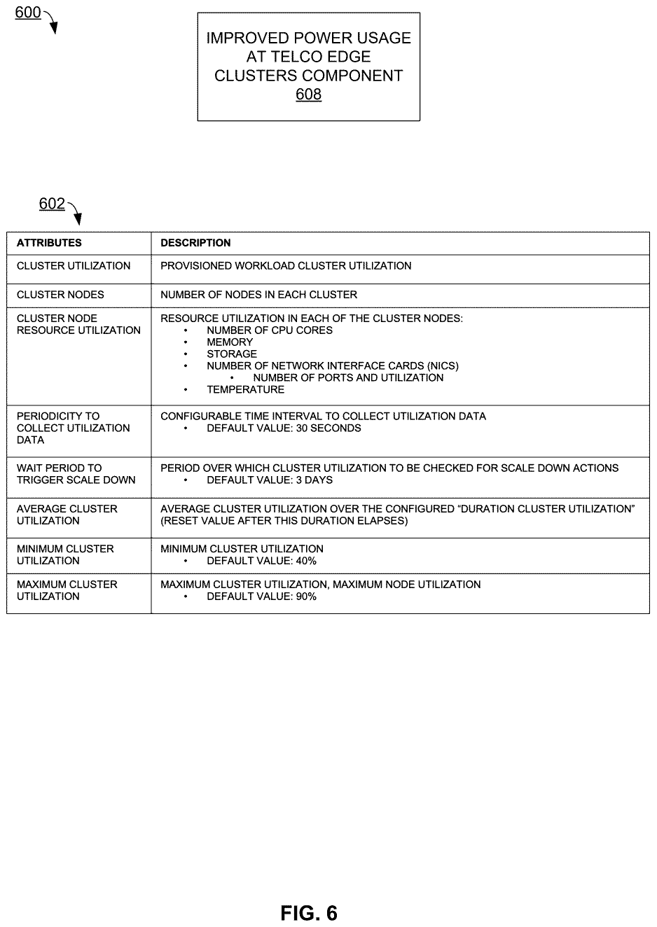

FIG. 6 illustrates an example table 600 of attributes, and that can facilitate improved power usage at telco edge clusters, in accordance with an embodiment of this disclosure. In some examples, part(s) of table 600 can be implemented by part(s) of system architecture 100 of FIG. 1 to facilitate improved power usage at telco edge clusters.

Table 600 comprises table 602 and improved power usage at telco edge clusters component 608 (which can be similar to improved power usage at telco edge clusters component 108A of FIG. 1).

At an infra-automation/central cluster, details about the cluster utilization at run-time can be available, such as are depicted. This information can be utilized according to the present techniques.

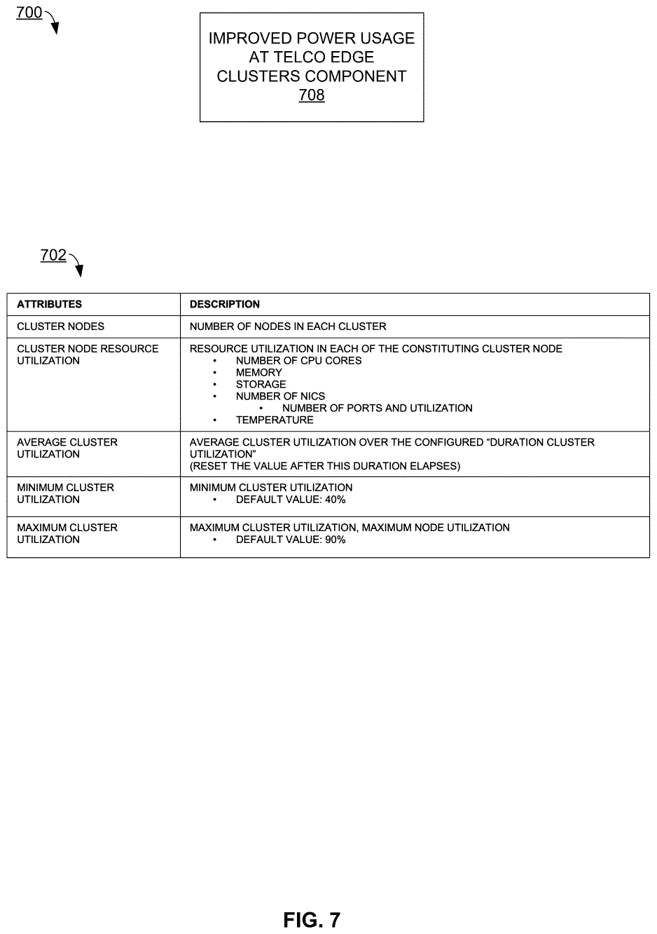

FIG. 7 illustrates another example table 700 of attributes, and that can facilitate improved power usage at telco edge clusters, in accordance with an embodiment of this disclosure. In some examples, part(s) of table 700 can be implemented by part(s) of system architecture 100 of FIG. 1 to facilitate improved power usage at telco edge clusters.

Table 700 comprises table 702 and improved power usage at telco edge clusters component 708 (which can be similar to improved power usage at telco edge clusters component 108A of FIG. 1).

A telemetry collector can periodically retrieve several data points from local deployment clusters and feed them to a local feature embeddings model, which can process these data points to generate anonymized embedding feature vectors, which can then be sent to the global AI model for training.

The attributes of a server that an AI enabled telemetry engine can query for are as follows:
Periodicity to collect utilization data (Default value: 30 seconds);
Period over which cluster utilization is to be checked for scale down actions (Default value: 3 days).

Each cluster's “available capacity” (Ac) can be determined by calculating the difference between “provisioned capacity” (Pc) and “utilized capacities” (Uc's).

If the reserved capacity is defined, then the “total available capacity” (Tac) can be determined by calculating the difference between Ac and “reserved capacity” (Rc) at the cluster level:

Ac=Pc−Uc

Tac=Ac−Rc

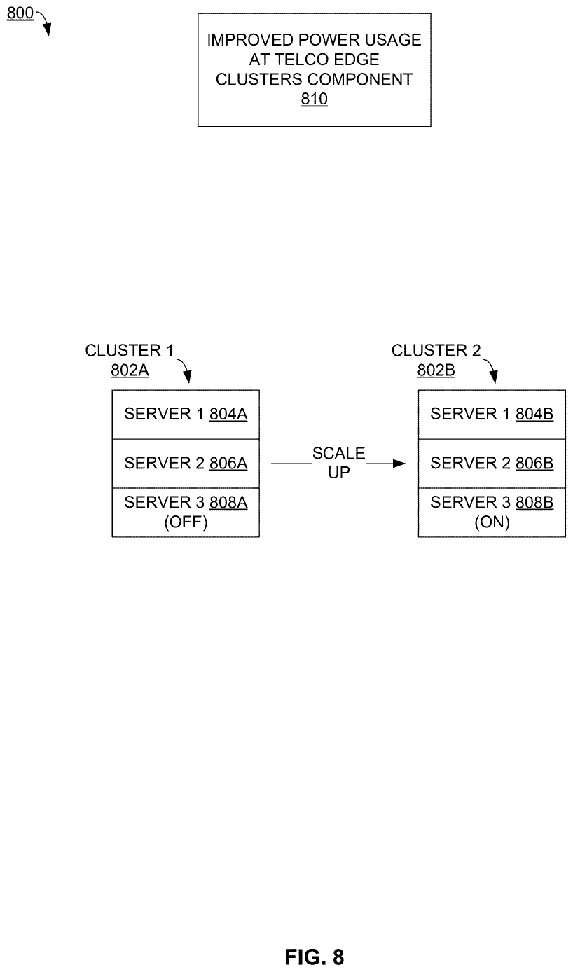

FIG. 8 illustrates an example 800 of scaling up, and that can facilitate improved power usage at telco edge clusters, in accordance with an embodiment of this disclosure. In some examples, part(s) of example 800 can be implemented by part(s) of system architecture 100 of FIG. 1 to facilitate improved power usage at telco edge clusters.

Example 800 comprises cluster 1 802A, cluster 2 802B, server 1 804A, server 1 804B, server 2 806A, server 2 806B, server 3 808A, server 3 808B, and improved power usage at telco edge clusters component 810 (which can be similar to improved power usage at telco edge clusters component 108A of FIG. 1).

The following can be performed in a scale-up scenario. When the AI engine predicts an increase of the workload, a new instance of a workload is to be instantiated to meet increased load demand, or an entirely new workload is to be instantiated to offer a different service, the following can be performed:
Iterate through each cluster to check whether it has available capacity to meet a workload deployment requirement specified in its manifest file.
   If a cluster is found that can meet the workload deployment requirement then deploy the workload.
   If a cluster lacks have sufficient capacity to meet the resource requirements to deploy the workload deployment, then:
      Obtain the resource from the ‘server inventory.” In some examples, server inventory can be dedicated. In other examples, sever inventory can be shared between data centers (DCs).
      If required resources are not available in the server inventory, then alert an administrator account.

Consider this scale-up example. At a given point in time only a total of 1.5 cluster nodes are utilized as depicted in cluster 1 802A. However, all three nodes are drawing power and utilizing proportionate cooling needs.

Similarly, at a given point in time, only single node worth is utilized as depicted in cluster 1 802B. However, all three nodes are drawing power and utilizing proportionate cooling needs.

Example 900 comprises cluster/server utilization 902, time 904, scale down threshold 906, actual utilization 908, prediction time window 910A, prediction time window 910B, prediction time window 910C, prediction time window 910D, prediction time window 910E, scale down time window 912A, and scale down time window 912B.

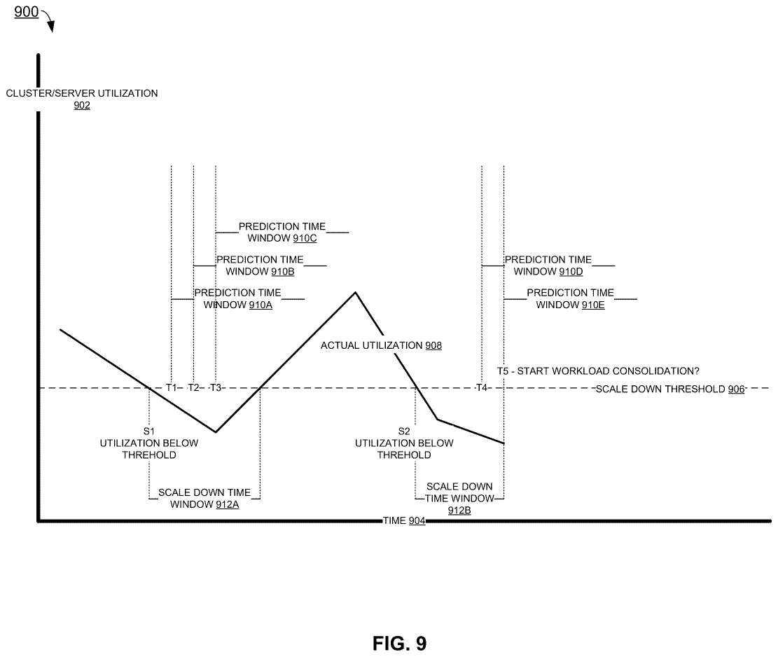

FIG. 9 illustrates an example 900 of scaling down, and that can facilitate improved power usage at telco edge clusters, in accordance with an embodiment of this disclosure. In some examples, part(s) of example 900 can be implemented by part(s) of system architecture 100 of FIG. 1 to facilitate improved power usage at telco edge clusters.

Consider the following scale-down example. When the utilization drops below a configurable scale down threshold (times s1 and s2), the system can trigger the periodic execution (at time intervals S: t1, t2, . . . t5) of the scale down approach. At each execution (at times tn, n=1, 2, . . . ), the AI engine can infer the value of the probability that the maximum utilization at any time during the next prediction window is below the “scale down threshold” (which can be a configurable value).

If the probability is greater than a configurable probability K (where higher K values imply a higher confidence):

Probability(max(utilization(t))<ScaleDownThreshold),t in [tn,tn+T])>K
then workload consolidation can start (time t5), if the AI engine predicts that other model parameters allow workload consolidation (e.g., a cluster to migrate the local workload to is available, based on constraints such as traffic latency and bandwidth requirements).

A first check can be made of whether average_cluster_utilization is less than the min_cluster_utilization, and cluster size is greater than min_cluster_size, and the maximum predicted utilization for the next prediction window is less than min_cluster_utilization.

If yes, then check whether there are nodes that are not being utilized. If yes, then trigger the workflow to remove node(s) from the cluster.

Otherwise—with respect to the first check, check whether there are under-utilized nodes and workload can be consolidated (while selecting target cluster-node(s) for consolidating the workload, current and predicted workload SLA requirements can be considered, e.g., data and control plane (signaling) packets latency, data traffic throughput along with tolerance) from these nodes to other under-utilized nodes, while making sure that max_node_utilization and the max_cluster_utilization do not exceed their configured value.

If workload consolidation is possible, then consolidate the workload(s).

Upon successful workload consolidation, trigger the workflow to remove node(s) from the cluster that are not being used now.

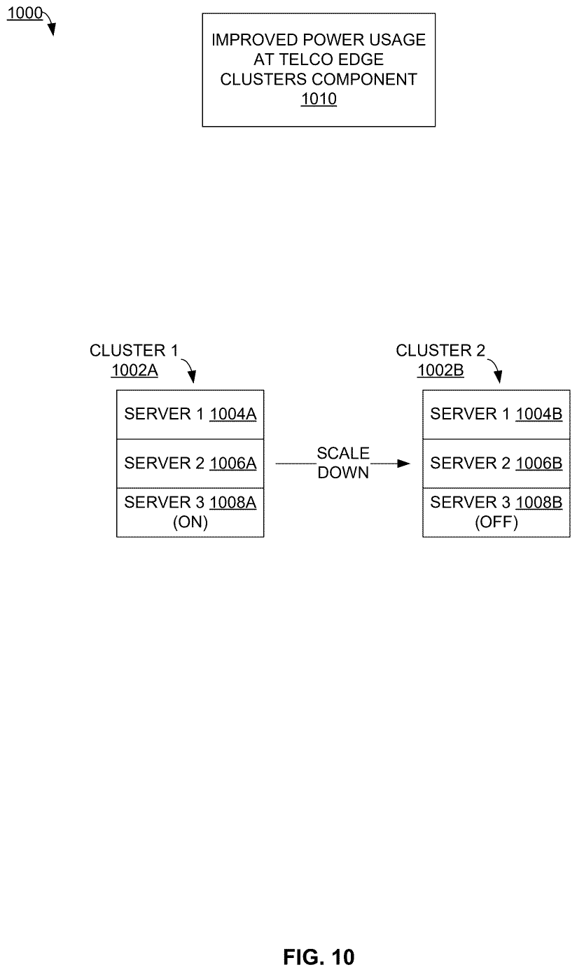

FIG. 10 illustrates another example 1000 of scaling down, and that can facilitate improved power usage at telco edge clusters, in accordance with an embodiment of this disclosure. In some examples, part(s) of example 1000 can be implemented by part(s) of system architecture 100 of FIG. 1 to facilitate improved power usage at telco edge clusters.

Example 1000 comprises cluster 1 1002A, cluster 2 1002B, server 1 1004A, server 1 1004B, server 2 1006A, server 2 1006B, server 3 1008A, server 3 1008B, and improved power usage at telco edge clusters component 1010 (which can be similar to improved power usage at telco edge clusters component 108B of FIG. 1).

In this example, over the period of time, the running average cluster CPU utilization is 50% which translates to only 1.5 worth of cluster nodes being utilized. However, all three nodes of the cluster are drawing power and utilizing proportionate cooling needs.

### Example Process Flows

FIG. 11 illustrates another example process flow 1100 that can facilitate improved power usage at telco edge clusters, in accordance with an embodiment of this disclosure. In some examples, one or more embodiments of process flow 1100 can be implemented by improved power usage at telco edge clusters component 108A and/or improved power usage at telco edge clusters component 108B of FIG. 1, or computing environment 1400 of FIG. 14.

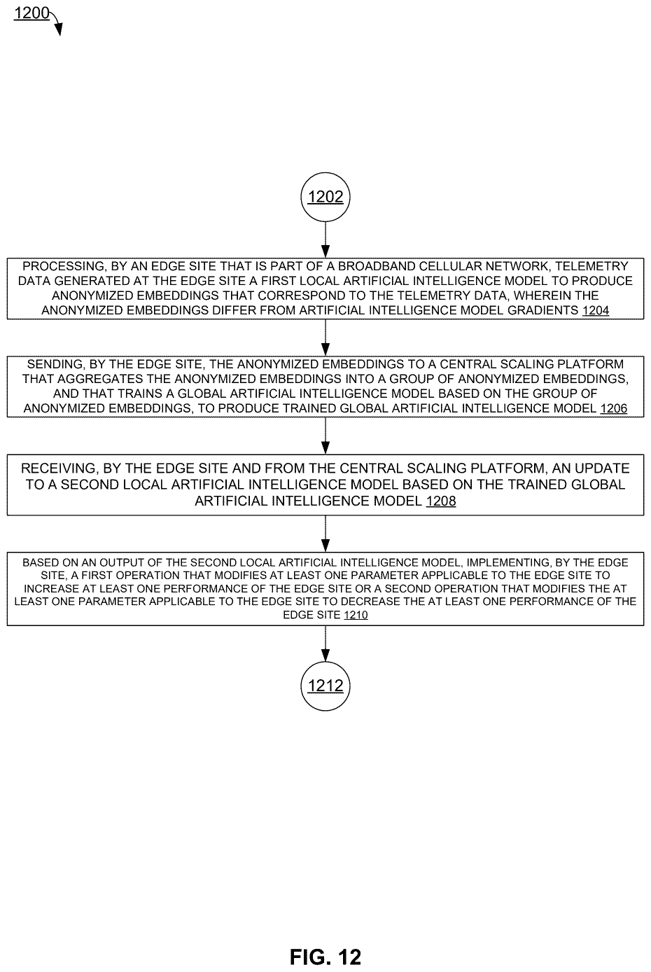

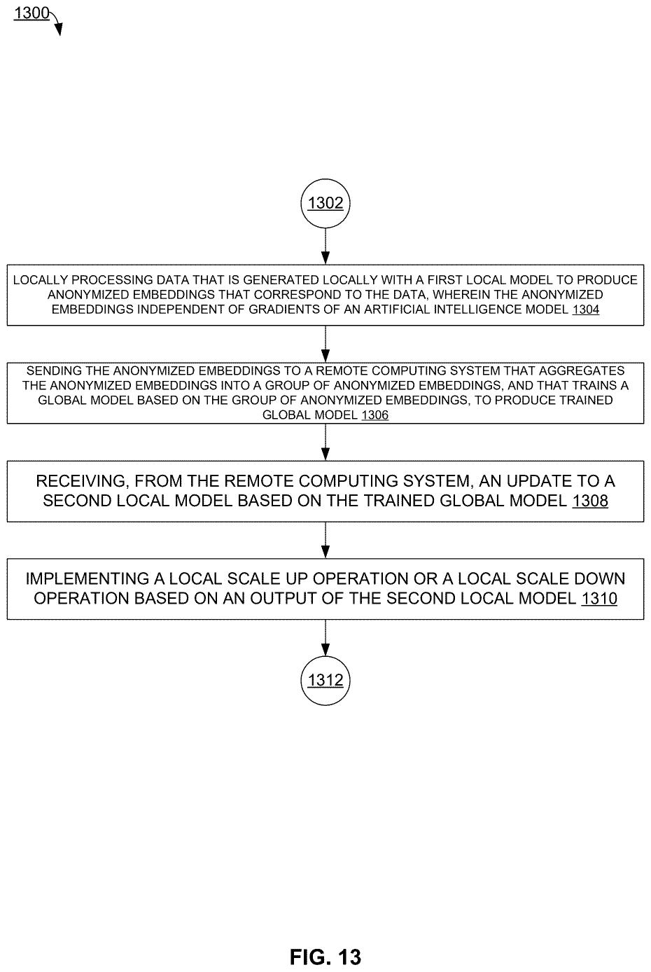

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 1200 of FIG. 12, and/or process flow 1300 of FIG. 13.

Process flow 1100 begins with 1102, and moves to operation 1104.

Operation 1104 depicts identifying data regarding facilitation of broadband cellular communications at the edge network equipment, wherein the edge network equipment is part of a broadband cellular network. Using the example of FIG. 2, this can comprise an instance of AI drive scale up/down platform 210 receiving cluster telemetry from an instance of 5G telco edge cluster 216.

After operation 1104, process flow 1100 moves to operation 1106.

Operation 1106 depicts processing the data using a first local artificial intelligence model to produce anonymized embeddings that correspond to the data, wherein the anonymized embeddings differ from artificial intelligence model gradients. Continuing with the example of FIG. 2, this can comprise local embeddings model 212 producing anonymized local embeddings.

In some examples operation 1106 comprises performing at least one iteration of the identifying and the processing. That is, a telemetry collector can periodically retrieve several data points from the local deployment clusters and feeds them to a local AI engine. The local AI engine can process these data points to update its parameters (e.g., AI model weights).

After operation 1106, process flow 1100 moves to operation 1108.

Operation 1108 depicts sending the anonymized embeddings to a central scaling platform that aggregates the anonymized embeddings into a group of anonymized embeddings, and that trains a global artificial intelligence model based on the group of anonymized embeddings, to produce trained global artificial intelligence model, wherein respective anonymized embeddings of the group of anonymized embeddings are received from respective edge network equipment of a group of edge network equipment that comprise the edge network equipment.

Continuing with the example of FIG. 2, this can comprise central scaling platform 202 receiving the anonymized local embeddings of operation 1106, and using them along with other anonymized local embeddings from other instances of AI drive scale up/down platform 210. Aggregator 206 can aggregate the anonymized local embeddings and global scale up/down model 208 can process the aggregated anonymized local embeddings to produce an AI scaling model.

In some examples, the broadband cellular network is associated with a first telecommunications service provider, and the global artificial intelligence model is trained based on a group of data from a group of telecommunications service providers that comprises the first telecommunications service provider. That is, a global AI model can be trained using anonymized data from one or more participating telcos.

In some examples, the group of edge network equipment is a first group of edge network equipment, the respective edge network equipment comprise a subset of a second group of edge network equipment, and the respective edge network equipment are selected from the second group of edge network equipment based on an availability criterion.

In some examples, the group of edge network equipment is a first group of edge network equipment, wherein the respective edge network equipment comprise a subset of a second group of edge network equipment, and wherein the respective edge network equipment are selected from the second group of edge network equipment based on a data quality criterion.

In some examples, the group of edge network equipment is a first group of edge network equipment, wherein the respective edge network equipment comprise a subset of a second group of edge network equipment, and wherein the respective edge network equipment are selected from the second group of edge network equipment based on a computational power criterion. That is, participating devices for training a global model can be selected based on factors like availability, data quality, and computational power.

After operation 1108, process flow 1100 moves to operation 1110.

Operation 1110 depicts receiving, from the central scaling platform, an update to a second local artificial intelligence model based on the trained global artificial intelligence model. Continuing with the example of FIG. 2, the update to the second local artificial intelligence model can comprise the AI scaling model.

In some examples, an input to the second local artificial intelligence model comprises a cluster utilization value, a number of nodes in a cluster, a cluster node resource utilization value, periodicity to collect utilization data value, a wait period to trigger scale down value, an average cluster utilization value, a minimum cluster utilization value, or a maximum cluster utilization value.

In some examples, operation 1110 comprises iteratively updating the second local artificial intelligence model based on a group of updates received from the central scaling platform, wherein the group of updates comprises the update. That is, a centralized AI model can periodically provide updates to the local controller to avoid AI model drift.

After operation 1110, process flow 1100 moves to operation 1112.

Operation 1112 depicts implementing a scale up operation or a scale down operation of the edge network equipment based on an output of the second local artificial intelligence model. Continuing with the example of FIG. 2, this can comprise scale up/down controller 214 making a scale up/down determination for an instance of 5G telco edge cluster 216, where a scale up can be similar to as depicted with respect to FIG. 8, and a scale down can be similar to as depicted with respect to FIGS. 9-10.

After operation 1112, process flow 1100 moves to 1114, where process flow 1100 ends.

FIG. 12 illustrates another example process flow 1200 that can facilitate improved power usage at telco edge clusters, in accordance with an embodiment of this disclosure. In some examples, one or more embodiments of process flow 1200 can be implemented by improved power usage at telco edge clusters component 108A and/or improved power usage at telco edge clusters component 108B of FIG. 1, or computing environment 1400 of FIG. 14.

It can be appreciated that the operating procedures of process flow 1200 are example operating procedures, and that there can be embodiments that implement more or fewer operating procedures than are depicted, or that implement the depicted operating procedures in a different order than as depicted. In some examples, process flow 1200 can be implemented in conjunction with one or more embodiments of one or more of process flow 1100 of FIG. 11, and/or process flow 1300 of FIG. 13.

Process flow 1200 begins with 1202, and moves to operation 1204.

Operation 1204 depicts processing, by an edge site that is part of a broadband cellular network, telemetry data generated at the edge site a first local artificial intelligence model to produce anonymized embeddings that correspond to the telemetry data, wherein the anonymized embeddings differ from artificial intelligence model gradients. In some examples, operation 1204 can be implemented in a similar manner as operations 1104-1106 of FIG. 11.

After operation 1204, process flow 1200 moves to operation 1206.

Operation 1206 depicts sending, by the edge site, the anonymized embeddings to a central scaling platform that aggregates the anonymized embeddings into a group of anonymized embeddings, and that trains a global artificial intelligence model based on the group of anonymized embeddings, to produce trained global artificial intelligence model. In some examples, operation 1206 can be implemented in a similar manner as operation 1108 of FIG. 11.

After operation 1206, process flow 1200 moves to operation 1208.

Operation 1208 depicts receiving, by the edge site and from the central scaling platform, an update to a second local artificial intelligence model based on the trained global artificial intelligence model. In some examples, operation 1208 can be implemented in a similar manner as operation 1110 of FIG. 11.

After operation 1208, process flow 1200 moves to operation 1210.

Operation 1210 depicts, based on an output of the second local artificial intelligence model, implementing, by the edge site, a first operation that modifies at least one parameter applicable to the edge site to increase at least one performance of the edge site or a second operation that modifies the at least one parameter applicable to the edge site to decrease the at least one performance of the edge site. In some examples, operation 1210 can be implemented in a similar manner as operation 1112 of FIG. 11.

In some examples, an input to the second local artificial intelligence model comprises at least one of a cluster utilization value, a number of nodes in a cluster, a cluster node resource utilization value, periodicity to collect utilization data value, a wait period to trigger scale down value, an average cluster utilization value, a minimum cluster utilization value, or a maximum cluster utilization value. This can be similar to the parameters of FIG. 6.

In some examples, the output of the second local artificial intelligence model comprises a predicted future load on the edge site, and operation 1210 comprises based on the predicted future load being determined to be greater than a current load, and based on determining that the edge site lacks a cluster with available capacity to execute the predicted future load, performing, by the edge site, the implementing of the first operation to increase the at least one performance of the edge site. In some examples, the determining that the edge site lacks the cluster with the available capacity to execute the predicted future load is performed separately from receiving the output of the second local artificial intelligence model. That is, scale up operations can be performed as described herein.

In some examples, the predicted future load comprises an increased resource utilization of a current workload, instantiation of a new instance of a current workload instance, or instantiation of a second type of workload that is not running as part of the current load. That is, an AI engine can predict an increase of the workload, a new instance of a workload that is to be instantiated to meet increased load demand, or an entirely new workload to be instantiated to offer a different service.

In some examples, the output of the second local artificial intelligence model comprises a predicted future load on the edge site, operation 1210 comprises, based on an average cluster utilization value of the edge site that corresponds to the predicted future load being determined to be less than a minimum cluster utilization value, based on a size of a cluster of the edge site being greater than a minimum cluster size value, and based on a maximum predicted utilization for a prediction window being less than the minimum cluster utilization value, wherein the maximum predicted utilization corresponds to the predicted future load, performing, by the edge site, the implementing of the second operation to decrease the at least one performance of the edge site.

In some examples, the performing of the implementing of the second operation to decrease the at least one performance of the edge site comprises performing the second operation further based on determining that the edge site comprises a computing node that is not being utilized to run a workload, and wherein the second operation comprises powering off the computing node.

In some examples, operation 1210 comprises, based on determining that the edge site lacks a computing node that is not being utilized to run a workload, consolidating, by the edge site, workloads of two nodes of the edge site to produce a utilized node and an unutilized node;, and powering off, by the edge site, the unutilized node.

This can involve operations based on average_cluster_utilization, min_cluster_utilization, and min_cluster_size, as described herein.

After operation 1210, process flow 1200 moves to 1212, where process flow 1200 ends.

FIG. 13 illustrates another example process flow 1300 that can facilitate improved power usage at telco edge clusters, in accordance with an embodiment of this disclosure. In some examples, one or more embodiments of process flow 1300 can be implemented by improved power usage at telco edge clusters component 108A and/or improved power usage at telco edge clusters component 108B of FIG. 1, or computing environment 1400 of FIG. 14.

It can be appreciated that the operating procedures of process flow 1300 are example operating procedures, and that there can be embodiments that implement more or fewer operating procedures than are depicted, or that implement the depicted operating procedures in a different order than as depicted. In some examples, process flow 1300 can be implemented in conjunction with one or more embodiments of one or more of process flow 1100 of FIG. 11, and/or process flow 1200 of FIG. 12.

Process flow 1300 begins with 1302, and moves to operation 1304.

Operation 1304 depicts locally processing data that is generated locally with a first local model to produce anonymized embeddings that correspond to the data, wherein the anonymized embeddings independent of gradients of an artificial intelligence model. In some examples, operation 1304 can be implemented in a similar manner as operations 1104-1106 of FIG. 11.

After operation 1304, process flow 1300 moves to operation 1306.

Operation 1306 depicts sending the anonymized embeddings to a remote computing system that aggregates the anonymized embeddings into a group of anonymized embeddings, and that trains a global model based on the group of anonymized embeddings, to produce trained global model. In some examples, operation 1306 can be implemented in a similar manner as operation 1108 of FIG. 11.

After operation 1306, process flow 1300 moves to operation 1308.

Operation 1308 depicts receiving, from the remote computing system, an update to a second local model based on the trained global model. In some examples, operation 1308 can be implemented in a similar manner as operation 1110 of FIG. 11.

After operation 1308, process flow 1300 moves to operation 1310.

Operation 1310 depicts implementing a local scale up operation or a local scale down operation based on an output of the second local model. In some examples, operation 1310 can be implemented in a similar manner as operation 1112 of FIG. 11.

In some examples, the local scale down operation comprises powering down a local computing node. That is, to conserve electrical power, existing underutilized workload cluster size can be reduced by powering down node(s) that are lightly utilized or not utilized.

In some examples, the local computing node is a first local computing node, and the local scale down operation comprises transferring a workload from the first local computing node to at least one second local computing edge note, before performing the powering down. That is, workloads can be consolidated from a larger group of nodes to a smaller group of nodes to facilitate conserving electrical power by powering down nodes.

In some examples, the local scale up operation comprises powering up a local computing node, wherein the computing node is installed locally before determining to implement the scale up operation, and wherein the powering up of the computing node results in an increase in a local computing capacity. That is, when the existing edge cluster compute capacity is insufficient to meet the workload deployment requirements, new servers/node(s) can be powered up and added to the cluster to increase its capacity (“scale up”). In some examples, this can refer to powered off pre-installed servers, and not installation of new servers.

After operation 1310, process flow 1300 moves to 1312, where process flow 1300 ends.

### Example Operating Environment

In order to provide additional context for various embodiments described herein, FIG. 14 and the following discussion are intended to provide a brief, general description of a suitable computing environment 1400 in which the various embodiments of the embodiment described herein can be implemented.

For example, parts of computing environment 1400 can be used to implement one or more embodiments of central platform 102, local platforms 104, and/or telco edge clusters 106.

In some examples, computing environment 1400 can implement one or more embodiments of the process flows of FIGS. 11-13 to facilitate improved power usage at telco edge clusters.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a nonvolatile storage such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 can also be configured for external use in a suitable chassis (not shown). Additionally, while not shown in environment 1400, a solid state drive (SSD) could be used in addition to, or in place of, an HDD 1414. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the . NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are examples, and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. Edge network equipment, comprising:
at least one processor; and
at least one memory that stores executable instructions that, when executed by the at least one processor, facilitate performance of operations, comprising:
identifying data regarding facilitation of broadband cellular communications at the edge network equipment, wherein the edge network equipment is part of a broadband cellular network;
processing the data using a first local artificial intelligence model to produce anonymized embeddings that correspond to the data, wherein the anonymized embeddings differ from artificial intelligence model gradients;
sending the anonymized embeddings to a central scaling platform that aggregates the anonymized embeddings into a group of anonymized embeddings, and that trains a global artificial intelligence model based on the group of anonymized embeddings, to produce trained global artificial intelligence model, wherein respective anonymized embeddings of the group of anonymized embeddings are received from respective edge network equipment of a group of edge network equipment that comprise the edge network equipment;
receiving, from the central scaling platform, an update to a second local artificial intelligence model based on the trained global artificial intelligence model; and
implementing a scale up operation or a scale down operation of the edge network equipment based on an output of the second local artificial intelligence model.

2. The edge network equipment of claim 1, wherein an input to the second local artificial intelligence model comprises a cluster utilization value, a number of nodes in a cluster, a cluster node resource utilization value, periodicity to collect utilization data value, a wait period to trigger scale down value, an average cluster utilization value, a minimum cluster utilization value, or a maximum cluster utilization value.

3. The edge network equipment of claim 1, wherein the broadband cellular network is associated with a first telecommunications service provider, and wherein the global artificial intelligence model is trained based on a group of data from a group of telecommunications service providers that comprises the first telecommunications service provider.

4. The edge network equipment of claim 1, wherein the operations further comprise:
iteratively updating the second local artificial intelligence model based on a group of updates received from the central scaling platform, wherein the group of updates comprises the update.

5. The edge network equipment of claim 1, wherein the group of edge network equipment is a first group of edge network equipment, wherein the respective edge network equipment comprise a subset of a second group of edge network equipment, and wherein the respective edge network equipment are selected from the second group of edge network equipment based on an availability criterion.

6. The edge network equipment of claim 1, wherein the group of edge network equipment is a first group of edge network equipment, wherein the respective edge network equipment comprise a subset of a second group of edge network equipment, and wherein the respective edge network equipment are selected from the second group of edge network equipment based on a data quality criterion.

7. The edge network equipment of claim 1, wherein the group of edge network equipment is a first group of edge network equipment, wherein the respective edge network equipment comprise a subset of a second group of edge network equipment, and wherein the respective edge network equipment are selected from the second group of edge network equipment based on a computational power criterion.

8. The edge network equipment of claim 1, wherein the operations further comprise:
performing at least one iteration of the identifying and the processing.

9. A method, comprising:
processing, by an edge site comprising at least one processor and that is part of a broadband cellular network, telemetry data generated at the edge site a first local artificial intelligence model to produce anonymized embeddings that correspond to the telemetry data, wherein the anonymized embeddings differ from artificial intelligence model gradients;
sending, by the edge site, the anonymized embeddings to a central scaling platform that aggregates the anonymized embeddings into a group of anonymized embeddings, and that trains a global artificial intelligence model based on the group of anonymized embeddings, to produce trained global artificial intelligence model;
receiving, by the edge site and from the central scaling platform, an update to a second local artificial intelligence model based on the trained global artificial intelligence model; and
based on an output of the second local artificial intelligence model, implementing, by the edge site, a first operation that modifies at least one parameter applicable to the edge site to increase at least one performance of the edge site or a second operation that modifies the at least one parameter applicable to the edge site to decrease the at least one performance of the edge site.

10. The method of claim 9, wherein an input to the second local artificial intelligence model comprises at least one of a cluster utilization value, a number of nodes in a cluster, a cluster node resource utilization value, periodicity to collect utilization data value, a wait period to trigger scale down value, an average cluster utilization value, a minimum cluster utilization value, or a maximum cluster utilization value.

11. The method of claim 9, wherein the output of the second local artificial intelligence model comprises a predicted future load on the edge site, and further comprising:
based on the predicted future load being determined to be greater than a current load, and based on determining that the edge site lacks a cluster with available capacity to execute the predicted future load, performing, by the edge site, the implementing of the first operation to increase the at least one performance of the edge site.

12. The system of claim 11, wherein the determining that the edge site lacks the cluster with the available capacity to execute the predicted future load is performed separately from receiving the output of the second local artificial intelligence model.

13. The method of claim 11, wherein the predicted future load comprises an increased resource utilization of a current workload, instantiation of a new instance of a current workload instance, or instantiation of a second type of workload that is not running as part of the current load.

14. The method of claim 9, wherein the output of the second local artificial intelligence model comprises a predicted future load on the edge site, and further comprising:
based on an average cluster utilization value of the edge site that corresponds to the predicted future load being determined to be less than a minimum cluster utilization value, based on a size of a cluster of the edge site being greater than a minimum cluster size value, and based on a maximum predicted utilization for a prediction window being less than the minimum cluster utilization value, wherein the maximum predicted utilization corresponds to the predicted future load, performing, by the edge site, the implementing of the second operation to decrease the at least one performance of the edge site.

15. The method of claim 14, wherein the performing of the implementing of the second operation to decrease the at least one performance of the edge site comprises performing the second operation further based on determining that the edge site comprises a computing node that is not being utilized to run a workload, and wherein the second operation comprises powering off the computing node.

16. The method of claim 14, further comprising:
based on determining that the edge site lacks a computing node that is not being utilized to run a workload, consolidating, by the edge site, workloads of two nodes of the edge site to produce a utilized node and an unutilized node; and
powering off, by the edge site, the unutilized node.

17. A non-transitory computer-readable medium comprising instructions that, in response to execution, cause a system comprising at least one processor to perform operations, comprising:
locally processing data that is generated locally with a first local model to produce anonymized embeddings that correspond to the data, wherein the anonymized embeddings independent of gradients of an artificial intelligence model;
sending the anonymized embeddings to a remote computing system that aggregates the anonymized embeddings into a group of anonymized embeddings, and that trains a global model based on the group of anonymized embeddings, to produce trained global model;
receiving, from the remote computing system, an update to a second local model based on the trained global model; and
implementing a local scale up operation or a local scale down operation based on an output of the second local model.

18. The non-transitory computer-readable medium of claim 17, wherein the local scale down operation comprises:
powering down a local computing node.

19. The non-transitory computer-readable medium of claim 18, wherein the local computing node is a first local computing node, and wherein the local scale down operation comprises:
transferring a workload from the first local computing node to at least one second local computing edge note, before performing the powering down.

20. The non-transitory computer-readable medium of claim 17, wherein the local scale up operation comprises:
powering up a local computing node, wherein the computing node is installed locally before determining to implement the scale up operation, and wherein the powering up of the computing node results in an increase in a local computing capacity.
